(19) United States
(12) Patent Application Publication
(10) Pub. No.: US 2008/0289472 A1
(43) Pub. Date: Nov. 27, 2008

(54) SKIDLOADER MOUNTED TIMBERSAW ATTACHMENT

(76) Inventor: JASON WILLIAM BALLOU, NEWELL, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/751,148

(22) Filed: May 21, 2007

(51) Int. Cl. B23D 57/00; A01G 23/02

(52) U.S. Cl. 83/788; 144/335

(57) ABSTRACT

A timbersaw attachment for a skidloader is beneficial in cutting timber. The skidloader attachment has a mounting plate adapted to attach to the skidloader, a cutting head attached to the mounting plate and one or more extensible members adapted to move the cutting head. Using the timbersaw attachment for a skidloader and method for cutting timber is disclosed by joining the attachment having a cutting head to the skidloader, connecting one or more extensible members and a motor on the attachment to the skidloader's hydraulics, moving the cutting head relative to the skidloader with the extensible members, and cutting timber with a chain rotated by the motor upon the cutting head.

### FIELD OF THE INVENTION

The present invention relates to a timbersaw attachment for use with a skidloader.

### BACKGROUND OF THE INVENTION

Skidloaders have proven useful in various and sundry applications as a result of the numerous attachments currently available. These attachments range from a bucket and brush for sweeping to an auger for drilling and forks for lifting. Some attachments have been designed specifically for use in the logging industry. One example is a log grapple attachment used to transport logs. Another example of an attachment used for cutting wood is a tree shear attachment. The tree shear attachment is essentially a giant hydraulic scissor that relies on the brute force of the scissors to burst through the branch or trunk of the tree. Because the tree shear attachment relies on hydraulic scissors to snap through the tree, the shears are limited by many factors, such as the size of the branch, limb or tree, the type of tree, the hydraulic force on the shears, and the material strength of the shears. Furthermore, tree shears are not the safest way to fell or prune a tree due to the unpredictability of which way the tree or branch will descend.

For many decades the tool of choice in the logging, pruning and harvesting of timber has been the chainsaw. The chainsaw has proven to be the best cutting method available for timber cutting. However, the chainsaw is not free from disadvantages. For example, those having used a chainsaw for any period of time quickly recognize and experience the physical stresses that result from operating the saw and the heightened sense of awareness needed while handling and using the saw due to the cutting chain and the close proximity of the operator with respect to the saw. Therefore, there is a need to combine the usefulness of the skidloader with a saw having all the benefits of the chainsaw, but without some of the attendant risks.

Operating a chainsaw by hand provides the operator with the necessary freedom to cut into the tree, branch or limb at certain angles and/or positions. For example, the operator is able to cut a wedge out of one side of the standing tree to fell the tree to a predictable location or position. Further, once the tree is felled, the operator can then proceed to cut the tree in specific lengths. Therefore, there is a need to provide a skidloader mounted timbersaw attachment that offers the same flexibility as if the saw were being held and operated by hand. For example, there is a need to provide a timbersaw attachment for a skidloader that is capable of creating a scissor action on the cutting head and changing the angle of the cutting head to mimic the cutting action of a hand held and operated chainsaw.

It is well known that chainsaws operate using a reciprocating engine which exposes the operator to toxic heat, emissions, vibration and fatigue. Therefore, there is a need to provide a timbersaw attachment for a skidloader wherein the chain may be driven by a hydraulic motor to reduce the operator's exposure.

It is well known that skidloaders offer a protective cage wherein the operator resides and may operate the loader and any attachment to the loader. It is also well known in the art that many dangers are inherent to operating a chainsaw to fell a tree, trim limbs or branches or cut timber. For example, because the operator holds the saw, there are increased chances for the operator to come into contact with the chain, hot surfaces on the chainsaw, and errant cuttings from the chain. Ultimately, the possibility of having a tree, limb or branch fall on the operator exists when using a chainsaw to fell or prune a tree. Therefore, there is a need to provide a timbersaw attachment for a skidloader that moves the operator away from the chain and opportunity for injury by placing the operator in the protective cabin of the skidloader to operate the timbersaw attachment. In the cabin of the skidloader, the operator would be protected from contact with the cutting head of the chain, errant debris from the chain, hot surfaces, and falling objects, such as limbs, branches or trees.

### BRIEF SUMMARY OF THE INVENTION

Therefore it is a primary object, feature, or advantage of the present invention to improve over the state of the art for timber saws.

It is a further object, feature, or advantage of the present invention to provide a skidloader mounted timbersaw attachment wherein movement of the cutting head is designed to mimic the cutting action of a handheld and operated chainsaw.

Yet another object, feature, or advantage of the present invention is to provide a skidloader mounted timbersaw attachment wherein movement of the cutting head and operation of the chain is operated using the skidloader's hydraulics.

A further object, feature, or advantage of the present invention is to provide a skidloader mounted timbersaw attachment wherein movement of the cutting head and operation of the chain is controllable from within the secure and safe environment of the protective cabin of the skidloader.

Yet another object, feature, or advantage of the present invention is to provide a skidloader mounted timbersaw attachment wherein a hydraulic motor operates the chain on the cutting head to reduce the operator's exposure to vibration and emissions.

One or more of these and/or other objects, features, or advantages of the present invention will become apparent from the specification and claims that follow.

According to one aspect of the present invention, a timbersaw attachment for a skidloader is disclosed. The timbersaw attachment has a cutting head adapted to attach to an attachment carrier plate on lift arms of the skidloader. The cutting head has a frame to thereby support rotation of a cutting chain about a bar for cutting timber. In the preferred form, the timbersaw attachment has a hydraulic assembly for connecting to the skidloader's hydraulics and for moving and operating the cutting head. The timbersaw attachment also has one or more controls for controlling the position of the cutting head and rotation of the chain which are positioned inside the skidloader.

A new method for cutting timber with a timbersaw attachment for a skidloader is disclosed. The method includes joining the timbersaw attachment having a cutting head to the skidloader, connecting one or more extensible members and a motor on the timbersaw attachment to the skidloader's hydraulics, articulating the cutting head relative to the skidloader with the extensible members, and cutting timber with a chain rotated about a bar on the cutting head by the motor. In a preferred form, the method also includes operating one of the extensible members to change a pitch angle of the cutting head relative to the skidloader, operating one of the extensible members for controlling a scissor motion of the cutting head with respect to the skidloader, and controlling the extensible members with one or more valves in fluid communication with the skidloader's hydraulics.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings in which:

FIG. 1A is a side elevation view of the skidloader mounted timbersaw attachment according to an exemplary embodiment of the present invention.

FIG. 1B is another side elevation view of the skidloader mounted timbersaw attachment according to an exemplary embodiment of the present invention.

FIG. 2A is a front elevation view of the skidloader mounted timbersaw attachment according to an exemplary embodiment of the present invention.

FIG. 2B is another front elevation view of the skidloader mounted timbersaw attachment according to an exemplary embodiment of the present invention.

FIG. 3A is a plan view of the skidloader mounted timbersaw attachment according to an exemplary embodiment of the present invention.

FIG. 3B is another plan view of the skidloader mounted timbersaw attachment according to an exemplary embodiment of the present invention.

FIG. 4 is a hydraulic schematic for the skidloader mounted timbersaw attachment according to an exemplary embodiment of the present invention.

The present invention includes a number of aspects, all of which have broad and far-reaching application for enhancing the devices embodying the inventions here described. One aspect of the present invention relates to the use of a skidloader mounted timbersaw attachment wherein movement of the cutting head is designed to mimic the cutting action of a handheld and operated chainsaw.

Another aspect of the present invention relates to a skidloader mounted timbersaw attachment wherein movement of the cutting head and operation of the chain is operated using the skidloader's hydraulics.

Another aspect of the present invention relates to the use of a skidloader mounted timbersaw attachment wherein movement of the cutting head and operation of the chain is controllable from within the secure and safe environment of the protective cabin of the skidloader.

Still another aspect of the present invention relates to a skidloader mounted timbersaw attachment wherein a hydraulic motor operates the chain on the cutting head to reduce the operator's exposure to vibration and emissions.

Although specific embodiments are described herein, the present invention is not to be limited to these specific embodiments. The present invention contemplates numerous other options in the design and use of the skidloader mounted timbersaw attachment.

### DETAILED DESCRIPTION OF THE PREFERRED EMBODIMENT

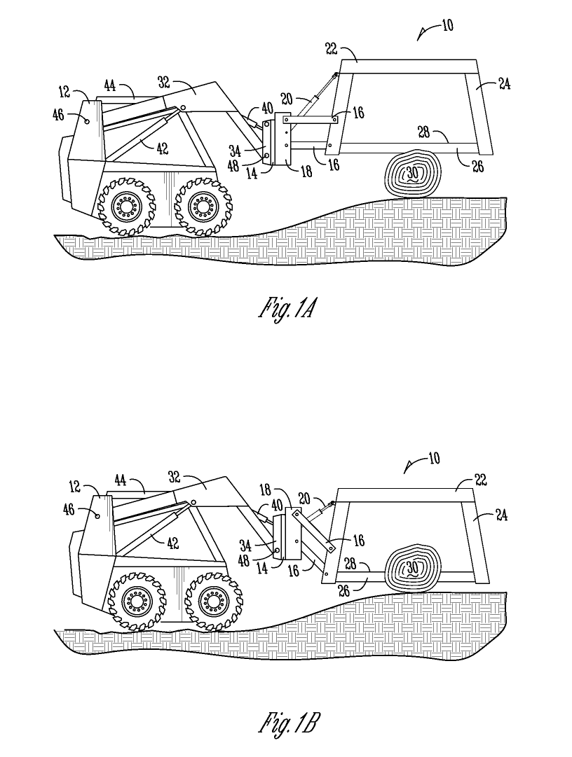

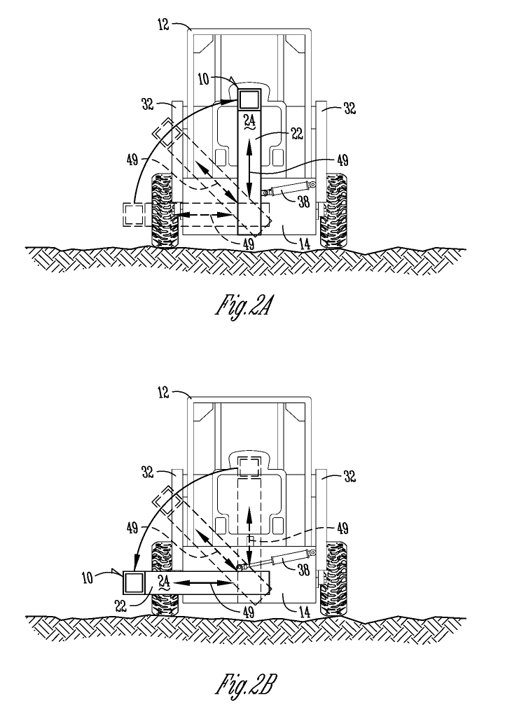

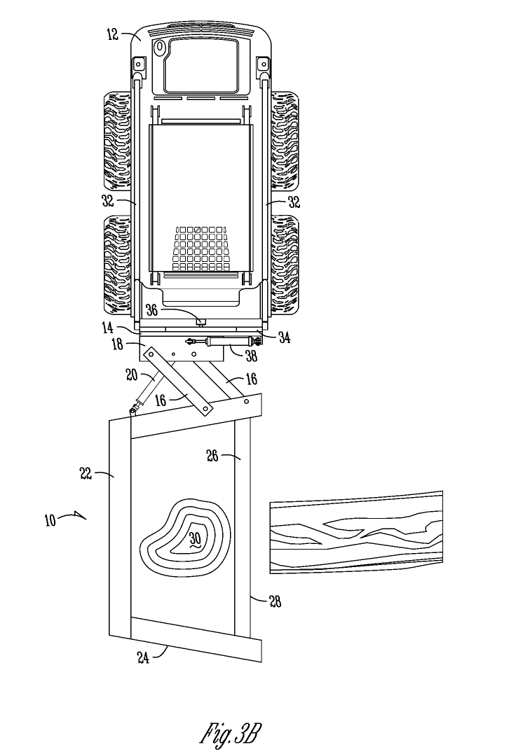

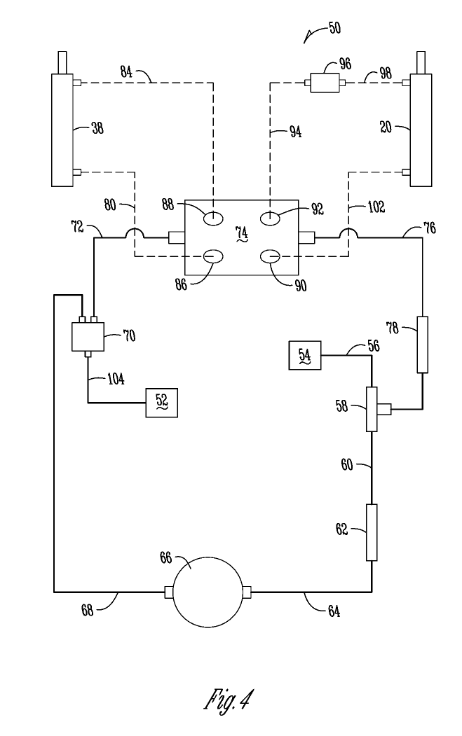

The timbersaw attachment 10 is best illustrated in FIGS. 1A-4. As is customary with most skidloaders 12, each lift-arm 32 terminates at a pivot point 46 near the back of the skidloader 12 and an attachment carrier plate 34 near the front of the skidloader 12. The attachment carrier plate 34 is part of the structure of the lift-arm 32. As is also customary with most skidloaders, such as skidloader 12 shown in FIG. 1A, the attachment carrier plate 34 is pivotally attached at 48 to the lift-arm 32 and articulated by extensible member 40 about the pivotable connection 48 between the lift-arm 32 and the attachment carrier plate 34. The extensible member 40 provides the operator of the skidloader 12 with a means of pivoting the attachment carrier plate 34 clockwise and counterclockwise with respect to the pivot connection 48. Moreover, each lift-arm 32 pivots clockwise and counterclockwise relative to a pivot connection 46 near the rear of the skidloader 12. An extensible member 42 is connected to each lift-arm and the frame of the skidloader 12 to articulate the lift-arm 32 with respect to the pivotable connection 46. Extending the extensible member 42 raises the elevation of the attachment carrier plate 34 with respect to the skidloader 12. Both extensible member 42 and 40 are controlled from within the protective cabin 44 of the skidloader 12. Also, as is customary with most skidloaders, extensible member 42 and 40 are hydraulically driven by a hydraulic pump operated or driven by the skidloader's engine. An operator can reside within the protective cabin 44 of the skidloader 12 and operate controls (not shown) to move the attachment carrier plate 34, activate extensible member 42 and/or extensible member 40. To facilitate quick connection of various types of attachments for the skidloader 12, skidloader manufacturers have configured the attachment carrier plate 34 so that attachments can be quickly “hooked up to” the attachment carrier plate 34.

In an exemplary embodiment of the present invention, the timbersaw attachment 10 has a mounting plate 14 that is adapted to quickly mate and attach to the attachment carrier plate 34 of the skidloader 12. Attached to the attachment carrier plate 34, the mounting plate 14 is capable of being pivoted about pivot connection point 48 by extensible member 40 or raised in elevation with respect to the skidloader 12 by extensible member 42.

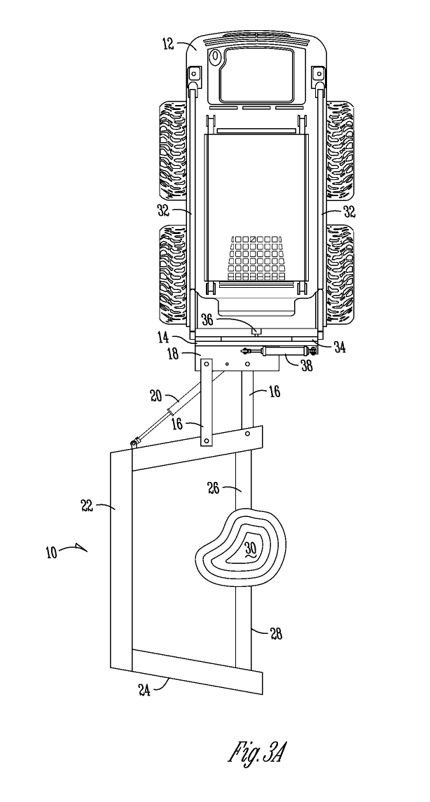

Rotatably connected to the mounting plate 14 is a pitch angle plate 18. The pitch angle plate 18 articulates about the mounting plate 14 from the vertical position shown in FIGS. 1A and 2A to the horizontal position shown in FIGS. 2A, 2B, 3 and 4. Movement of the pitch angle plate 18 is provided by extensible member 38 (shown in FIGS. 2A, 2B, 3 and 4). One end of the extensible member 38 is pivotally attached to the mounting plate 14 and the opposite end to the pitch angle plate 18. The pitch angle plate 18 moves from the vertical position shown in FIG. 2A to the horizontal position shown in FIG. 2B when the extensible member 38 is moved from the retracted position shown in FIG. 2A to the extended position shown in FIG. 2B. Similarly, the extensible member 38 may be partially extended so as to position the pitch angle plate 18 in a 45° angle with respect to the vertical position shown in FIG. 2A or the horizontal position shown in FIG. 2B. The pitch angle plate 18 is not limited to vertical, horizontal or a 45° angle, but may be pitched at any angle between the horizontal and vertical position shown in FIGS. 2A and 2B.

The timbersaw attachment 10 also has a cutting head 22. The cutting head 22 is pivotally attached to the pitch angle plate 18 by way of one or more connecting arms 16. By pivotally connecting each connecting arm 16 to the pitch angle plate 18 and the cutting head 22, the cutting head 22 is permitted to articulate about the pitch angle plate 18. To articulate the cutting head 22 with respect to the pitch angle plate 18 an extensible member 20 is pivotally attached to the cutting head 22 and the pitch angle plate 18. Extending the extensible member 20 articulates the cutting head 22 with respect to the pitch angle plate 18. Similarly, retracting the extensible member 20 articulates the cutting head 22 in an opposite direction with respect to the pitch angle plate 18. FIGS. 1A, 1B, 3 and 4 illustrate articulation of the cutting head 22 with respect to the pitch angle plate 18 along the vertical and horizontal plane, respectively. Movement of the cutting head 22, by adjusting extensible member 38 and 20 (shown in FIGS. 1A, 1B, 3 and 4) is also shown in FIGS. 2A and 2B. Movement arrows 49 show the path of travel of the cutting head 22 when extensible member 20 is extended and retracted. For example, the cutting head 22 can be positioned at a 45° angle (as shown in FIGS. 2A and 2B) using the extensible member 38 and scissored back and forth along movement arrow 49 using extensible member 20. The same motion holds true for any angle of the cutting head 22.

The cutting head 22 as shown in FIGS. 2A-4 has a frame 24 that is bow shaped for supporting a bar 26 on its opposite ends. A chain 28 is rotatably mounted on the bar 26. The chain 28 is preferably driven by a hydraulic motor. The chain may also be driven by other types of motors, such as a pneumatically, electrically or combustion driven motor. The chain 28 is rotated about the bar 26 for cutting through timber 30. Because the cutting head 22 is capable of articulating about the pitch angle plate 18 and the pitch angle plate 18 is subsequently capable of articulating about the mounting plate 14, the cutting head 22 is capable of mimicking the same cutting motions as a handheld chainsaw. For example, the timbersaw attachment 10 may be used to cut a notch out of a tree to fell the tree in a desired direction. Additionally, the cutting head 22 may be rocked upward and downward to thereby mimic a technique that is customary with operation of a handheld chainsaw.

In another exemplary application of the timbersaw attachment 10, using the lift-arm 32, the timbersaw attachment 10 may be elevated and positioned with respect to a limb in a tree for cutting the limb or pruning the tree. In any of the exemplary applications of the present invention, the operator may remain within the protective cabin 44 of the skidloader 12. This allows the operator to be removed from operation of the chain 28 on the bar 26 and any potential for injury from fallen timber. Similarly, because the operator is able to operate the timbersaw attachment 10 from within the protective cabin 44 the operator is removed from the physical fatigue that results from operation of a chainsaw, errant debris and materials from the cutting head 22. For example, any vibration resulting from the cutting head 22 is absorbed by the skidloader 12 rather than the operator. Moreover, because the chain 28 is rotated about the bar 26, preferably by a hydraulic motor (not shown), the operator is not exposed to the toxic fumes that are often associated with combustion driven chainsaws.

FIG. 5 shows a hydraulic schematic for operation of the timbersaw attachment 10 using the hydraulics of the skidloader 12. The hydraulic assembly 50 for operating the timbersaw attachment 10 connects to coupling outflow 52 and coupling inflow 54 of the skidloader 12. The coupling outflow 52 and inflow 54 are common connection points associated with almost all commercially available skidloaders. One skilled in the art would understand that the coupling outflow 52 and inflow 54 could be used to operate an attachment, such as the timbersaw attachment, as is customary with many attachments used with a skidloader 12. To connect the hydraulic assembly 50 of the timbersaw attachment 10 to the coupling outflow 52 and the coupling inflow 54 of the skidloader 12, hose 56 is coupled to a coupling inflow 54 and hose 104 is coupled to the coupling outflow 52. Pressurized hydraulic fluid from the skidloader 12 travels through coupling outflow 52 into hose 104 and into flow divider 70. The flow divider 70 is adjustable so that more or less of the hydraulic fluid may be prioritized to exit the flow divider 70 into either hose 72 or hose 68. For example, an exemplary embodiment of the present invention, flow divider 70 may be configured to give flow priority to the hydraulic motor 66 through hose 68, with the excess exiting the flow divider 70 into solenoid block 74 through hose 72. Hydraulic fluid entering the hydraulic motor 66 from hose 68 operates the hydraulic motor 66. The hydraulic motor 66 is preferably connected to the chain 28. In an exemplary embodiment of the present invention, the hydraulic motor 66 operates an output shaft with a sprocket thereon for rotating the chain 28 about the bar 26. Hydraulic fluid from the hydraulic motor 66 exits the hydraulic motor 66 through hose 64 and travels into check valve 62. Check valve 62 helps eliminate back pressure in hose 60 from acting on the hydraulic motor 66. From check valve 62, hydraulic fluid travels through hose 60 into tee 58. From tee 58, the hydraulic fluid travels through hose 56 into coupling inflow 54 of the skidloader 12.

On the other side of the flow divider 70, hydraulic fluid travels from the flow divider 70 through hose 72 into solenoid block 74. In an exemplary embodiment of the present invention, the solenoid block 74 may be 12-volt DC electric over hydraulic solenoid valves on a Do3 subplate dual station. Additionally, the solenoid block 74 may be controlled by handheld momentary dependence switches (not shown) positioned within the protective cabin 44 of the skidloader 12 for operation by the operator. Alternatively, the solenoid block 74 may be wired into the controls of the skidloader 12. The solenoid block 74 is adapted to controllably communicate hydraulic fluid from hose 72 into extensible member 38 and/or extensible member 20. For example, using controls within the protective cabin 44 of the skidloader 12, an operator can activate the solenoid block 74 so that hydraulic fluid travels out of the solenoid block 74 through extension feed 86 into hose 80 to thereby extend extensible member 38. Conversely, to retract the extensible member 38, the solenoid block 74 is activated to move hydraulic fluid through retraction feed 88 and hose 84 into the extensible member 38 to thereby retract extensible member 38. Hydraulic fluid within the extensible member 38, when retracted, is pushed out of the extensible member 38 into extension feed 86 of the solenoid block 74 through hose 80.

Extensible member 20 is similarly activated and operated. To extend the extensible member 20 hydraulic fluid exits the solenoid block 74 through extension feed 90 into the extensible member 20 through hose 102. As the extensible member 20 extends hydraulic fluid exits the extensible member 20 through hose 98 into flow control valve 96. By adjusting (dialing up or dialing down) the flow control valve 96, the flow rate of hydraulic fluid through the extensible member 20 may be controlled to thereby control the rate at which extensible member 20 extends and retracts. Hydraulic fluid from the flow control valve 96 travels through hose 94 into retraction feed 92 of the solenoid block 74 when the extensible member 20 is extended. Conversely, to retract the extensible member 20, hydraulic fluid, upon activation of the solenoid block 74, travels from retraction feed 92 through flow control valve 96 and into the extensible member 20. Hydraulic fluid within the extensible member 20 exits the extensible member 20 through hose 102 and travels into solenoid block 74 through extension feed 90. In either case, whether extending or retracting the extensible member 20, the flow control valve 96 can be used to control the rate of flow of hydraulic fluid to increase or decrease the speed at which the extensible member 20 operates. Additionally, it is understood that a flow control valve, such as the flow control valve 96, could be positioned in-line of hose 84 to thereby control the rate of hydraulic fluid flow through extensible member 38.

The preferred embodiment of the present invention has been set forth in the drawings and specification and though specific terms are employed, these are used in the generically descriptive sense only and are not used for the purposes of limitation. Changes in the form and proportion of parts as well as in the substitution of equivalents are contemplated as circumstances may suggest or are rendered expedient without departing from the spirit and scope of the invention as further defined in the following claims.

What is claimed is:

1. A timbersaw attachment for a skidloader comprises:
a mounting plate adapted to attach to an attachment carrier plate of the skidloader;
a cutting head for cutting timber attached and articulatable with respect to the mounting plate; and
one or more extensible members adapted to articulate the cutting head.

2. The timbersaw attachment of claim 1 wherein the cutting head further comprises a bar with a chain supported by a frame.

3. The timbersaw attachment of claim 2 wherein a hydraulic assembly having a hydraulic motor in fluid communication with the skidloader's hydraulics drives the chain for cutting timber.

4. The timbersaw attachment of claim 3 wherein the extensible members are in fluid communication with the skidloader's hydraulics and operated by the hydraulic assembly.

5. The timbersaw attachment of claim 1 wherein one extensible member controls a pitch angle of the cutting head.

6. The timbersaw attachment of claim 1 wherein one extensible member controls a scissor motion of the cutting head.

7. The timbersaw attachment of claim 3 wherein controls are in communication with one or more valves of the hydraulic assembly o thereby operate the extensible members from within the skidloader.

8. A method for cutting timber with a timbersaw attachment for a skidloader comprising:
joining the timbersaw attachment having a cutting head to the skidloader;
connecting one or more extensible members and a motor on the timbersaw attachment to the skidloader's hydraulics;
articulating the cutting head relative to the skidloader with the extensible members; and
cutting timber with a chain rotated about a bar on the cutting head by the motor.

9. The method of claim 8 further comprising the step of operating one of the extensible members to change a pitch angle of the cutting head relative to the skidloader.

10. The method of claim 8 further comprising the step of operating one of the extensible members for controlling a scissor motion of the cutting head with respect to the skidloader.

11. The method of claim 8 further comprising the step of controlling the extensible members with one or more valves in fluid communication with the skidloader's hydraulics.

12. A timbersaw attachment for a skidloader comprises:
a cutting head adapted to attach to an attachment carrier plate on lift-arms of the skidloader; and
the cutting head having a frame to thereby support rotation of a cutting chain about a bar for cutting timber.

13. The timbersaw attachment of claim 12 further comprises a hydraulic assembly for connecting to the skidloader's hydraulics and for moving and operating the cutting head.

14. The timbersaw attachment of claim 13 wherein the hydraulic assembly further comprises one or more valves in fluid communication with one or more extensible members and a motor for moving and operating the cutting head.

15. The timbersaw attachment of claim 12 wherein one or more controls for controlling the position of the cutting head and rotation of the chain are positioned inside the skidloader.

16. The timbersaw attachment of claim 12 wherein the frame is bowsaw in shape with first and second opposite ends to thereby support opposing ends of the bar.

17. The timbersaw attachment of claim 12 further comprises a hydraulically driven motor adapted to rotate the chain.

18. The timbersaw attachment of claim 12 further comprises a pitch angle plate pivotally connected to a mounting plate for attaching the cutting head to the attachment carrier plate.

19. A method for cutting timber with a timbersaw attachment for a skidloader, comprising:
providing a mounting plate , a cutting head having a bar with a chain attached to the mounting plate and one or more extensible members adapted to articulate the cutting head;
attaching the mounting plate to an attachment carrier plate of the skidloader;
connecting the extensible members and a motor on the timbersaw attachment to the skidloader's hydraulics;
articulating the cutting head relative to the skidloader with the extensible members; and
cutting timber with the chain rotated about the bar on the cutting head by the motor.
